(19) United States
(12) Patent Application Publication
(10) Pub. No.: US 2006/0017654 A1
(43) Pub. Date: Jan. 26, 2006

(54) Virtual reality interactivity system and method

(76) Inventor: Justin R. Romo, St. Louis, MO (US)

Correspondence Address: HARNESS, DICKEY, & PIERCE, P.L.C, 7700 BONHOMME, STE 400, ST. LOUIS, MO, 63105, US

(21) Appl. No.: 10/897,692

(22) Filed: Jul. 23, 2004

(51) Int. Cl. G09G 5/00; G06T 15/00; G09G 5/02

(52) U.S. Cl. 345/7; 345/419; 345/582; 345/592

(57) ABSTRACT

A virtual reality interactivity system and method of operation includes a plurality of position indicators that indicates a plurality of positions in a physical coordinate system each being associated with one of plurality of objects located within the physical environment mapped by the physical coordinate system. The system also includes a position communication system that communicates the plurality of positions of the plurality of position indicators. The system further includes a virtual reality user module associated with a user positioned within the physical environment. The virtual reality user module determines a position of an object within the physical coordinate system as a function of the plurality of position signals. The user module determines a position of an associated object within the virtual reality coordinate system and generates a virtual reality image signal that includes the determined position of the associated object within the virtual reality coordinate system. The user module also includes a virtual reality user interface that displays a virtual reality image to the user as a function of the virtual reality image signal.

### FIELD OF THE INVENTION

The present invention relates to computer simulated virtual reality systems and methods. More specifically, the invention is an interactive virtual reality system and method providing real-time interactivity between a physical environment and a virtual reality environment.

### BACKGROUND

Virtual reality is a technology for displaying a virtual environment to a user with the virtual environment appearing to the user to be a visually “real environment.” The virtual image or image signal is generated by a computer that allows a user to dissociate him from a physical environment and act as if in the virtual reality environment. Applications for virtual reality include video gaming, entertainment, military training simulations, law enforcement training simulations, fire fighter training simulations, NASA space simulations, flight simulations, science education simulations, and various medical, architectural and design applications. Recently, virtual reality systems have included 3-dimensional graphic images thereby making the virtual world appear more realistic and immersive. As computers and computer graphics advance, increased detailed computer graphics utilizing millions of polygons are used for virtual image construction. Virtual human images are now possible using laser scanning technologies to scan the body of a physical individual.

To create a virtual world with virtual images, images and textures are traditionally programmed into graphics engines. Additionally, images may be created from digitized photos or video or from scanned images. These virtual images and their three dimensional characterizations are stored in computer memory. These stored images are manipulated to produce a virtual reality image signal that is presented for displaying to the user often as a result of a user input or under computer programmed control.

Navigating the virtual environment and therefore selection of the virtual images for virtual signal generation was provided through the use of a joystick, keyboard, or mouse. Recently, navigation of the virtual environment has included physical movement by the user. For example, one way has been to immerse the user in a large hollow sphere and allow the user to walk along an inner surface of the sphere. Another way has been to place the user on an exterior surface of a sphere that is supported by base. A low friction interface is formed between the base support and a portion of the exterior surface of the sphere allowing the user to physically move along the exterior of the sphere while immersed in the virtual environment. Viewing the virtual images and the virtual environment has generally been in the form of a head-mounted display. User inputs for maneuvering in a virtual world have also includes user suits or clothing configured with wired movement sensors. These user inputs direct the image construction and presentation of the virtual reality images to the user.

However, virtual reality systems to date are just that, virtual images of a virtual world. When a user is viewing a virtual image within a virtual world, the user is separate and distinct from the physical world in which the user is located. As such, virtual reality systems have only limited application and functionality for many physical interactive applications such as enhanced gaming and training. Additionally, 3-dimensional graphic displays such as head-mounted displays and controls for viewing virtual environments are not well-suited to user interactivity with a physical environment as they are bulky, non-ergonomic and impractical. Systems that do allow limited user physical movement while immersed in the virtual reality environment remain limited in their ability to provide the user realistic corresponding movement in the virtual environment.

These and other limitations have been identified and addressed by the inventor.

### SUMMARY

One or more embodiments and aspects of a virtual reality system and method provides a user with interactivity between the virtual environment and the physical environment in which the user is located.

One aspect of the invention is a virtual reality user interface that includes a display having a transparent mode and a display mode. The transparent mode provides a user with transparent viewing. The display mode displays a virtual reality image. Also included is an audio interface generating an audible sound.

Another aspect of the invention is a virtual reality user module for generating a virtual reality image signal corresponding, at least in part, to a physical coordinate system. The virtual reality user module includes a communication module that receives a position signal from an object within a physical interactivity environment defined at least in part by the physical coordinate system. Also included is a processing module that determines a position of the object within the physical coordinate system responsive to the received position signal. The processing module also determines a position of an associated object within the virtual reality coordinate system and generates a virtual reality image signal that includes the determined position of the associated object within the virtual reality coordinate system.

In yet another aspect of the present invention is a virtual reality interactivity system. The system includes a plurality of position indicators that indicates a plurality of positions in a physical coordinate system each being associated with one of plurality of objects located within the physical environment mapped by the physical coordinate system. The system also includes a position communication system that communicates the plurality of positions of the plurality of position indicators. The system further includes a virtual reality user module associated with a user positioned within the physical environment. The virtual reality user module determines a position of an object within the physical coordinate system as a function of the plurality of position signals. The user module also determines a position of an associated object within the virtual reality coordinate system and generates a virtual reality image signal that includes the determined position of the associated object within the virtual reality coordinate system. The user module also includes a virtual reality user interface that displays a virtual reality image to the user as a function of the virtual reality image signal.

In still another aspect, the invention includes a method of operating a virtual reality user system. The method includes receiving a position signal from an object within a physical interactivity environment defined, at least in part, by a physical coordinate system. The method also includes determining a position of the object within the physical coordinate system as a function of the received position signal and determining a position of an associated object within the virtual reality coordinate system. The method further includes generating a virtual reality image signal including the associated object and the position of the associated object within the virtual reality coordinate system.

Further aspects of the invention will become apparent from the detailed description provided hereinafter. It should be understood that the detailed description and specific examples, while indicating various embodiments including the preferred embodiment of the invention, are intended for purposes of illustration only and are not intended to limit the scope of the invention.

### BRIEF DESCRIPTION OF THE DRAWINGS

FIG. 1 is an illustration of a virtual reality user interface and a virtual reality user module according to some embodiments of the invention.

FIG. 2A is an illustration of a rear view of a vest virtual reality user module according to one embodiment of the invention.

FIG. 2B is an illustration of a side view of a vest virtual reality user module according to one embodiment of the invention.

FIG. 3 is an illustration of a virtual reality user interface in the form of a helmet according to one embodiment of the invention.

FIG. 4 is an illustration of a virtual reality interactive hand held device according to one embodiment of the invention.

FIG. 5 is an illustration of a physical environment providing interactivity to a user between the virtual environment and the user's physical environment according to one embodiment of the invention.

FIG. 6 is an illustration of a physical environment communication system and interactions thereof according to one embodiment of the invention.

Corresponding reference characters indicate corresponding parts throughout the several views of the drawings.

### DETAILED DESCRIPTION

A virtual reality interactivity system and method of operation may be embodied or implemented in a variety of devices, systems, and methods. For example, in one embodiment a system may include a plurality of position indicators that indicates a plurality of positions in a physical coordinate system each being associated with one of plurality of objects located within the physical environment mapped by the physical coordinate system. The system also includes a position communication system that communicates the plurality of positions of the plurality of position indicators. The system further includes a virtual reality user module associated with a user positioned within the physical environment. The virtual reality user module determines a position of an object within the physical coordinate system as a function of the plurality of position signals. The user module determines a position of an associated object within the virtual reality coordinate system and generates a virtual reality image signal that includes the determined position of the associated object within the virtual reality coordinate system. The user module also includes a virtual reality user, interface that displays a virtual reality image to the user as a function of the virtual reality image signal.

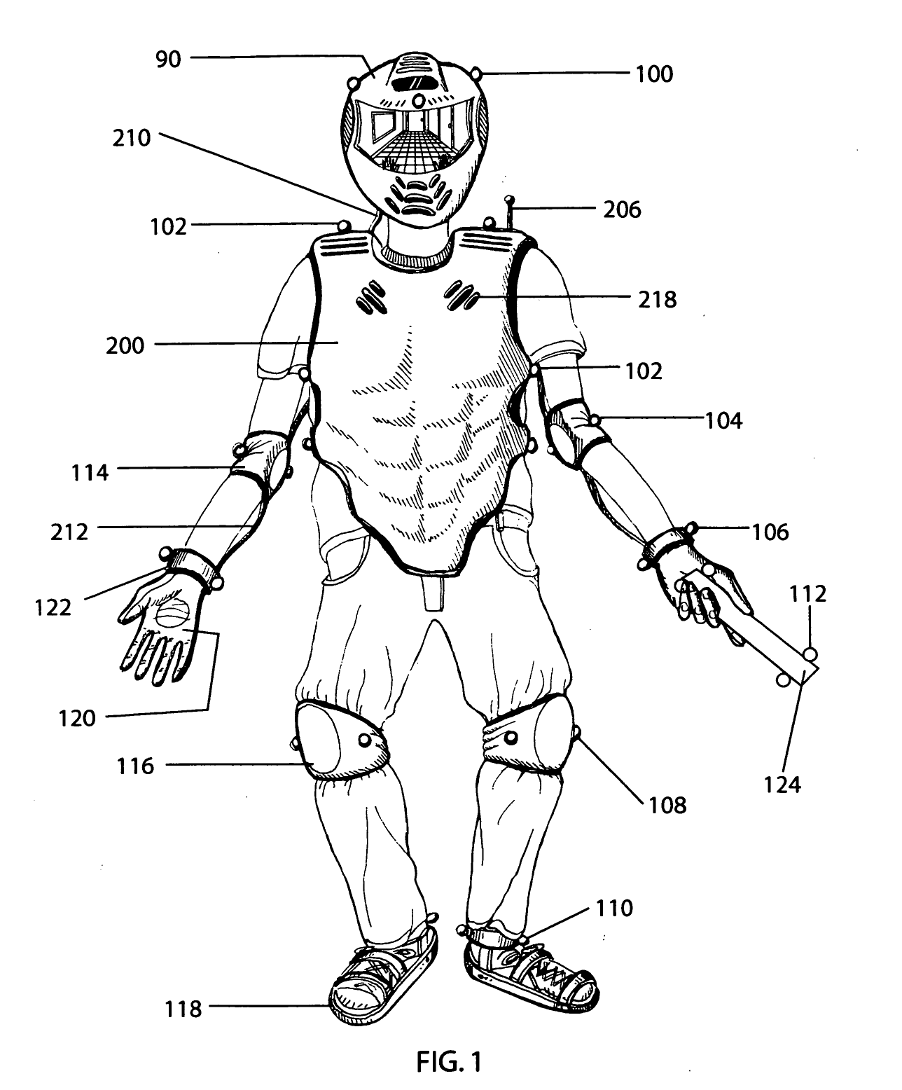

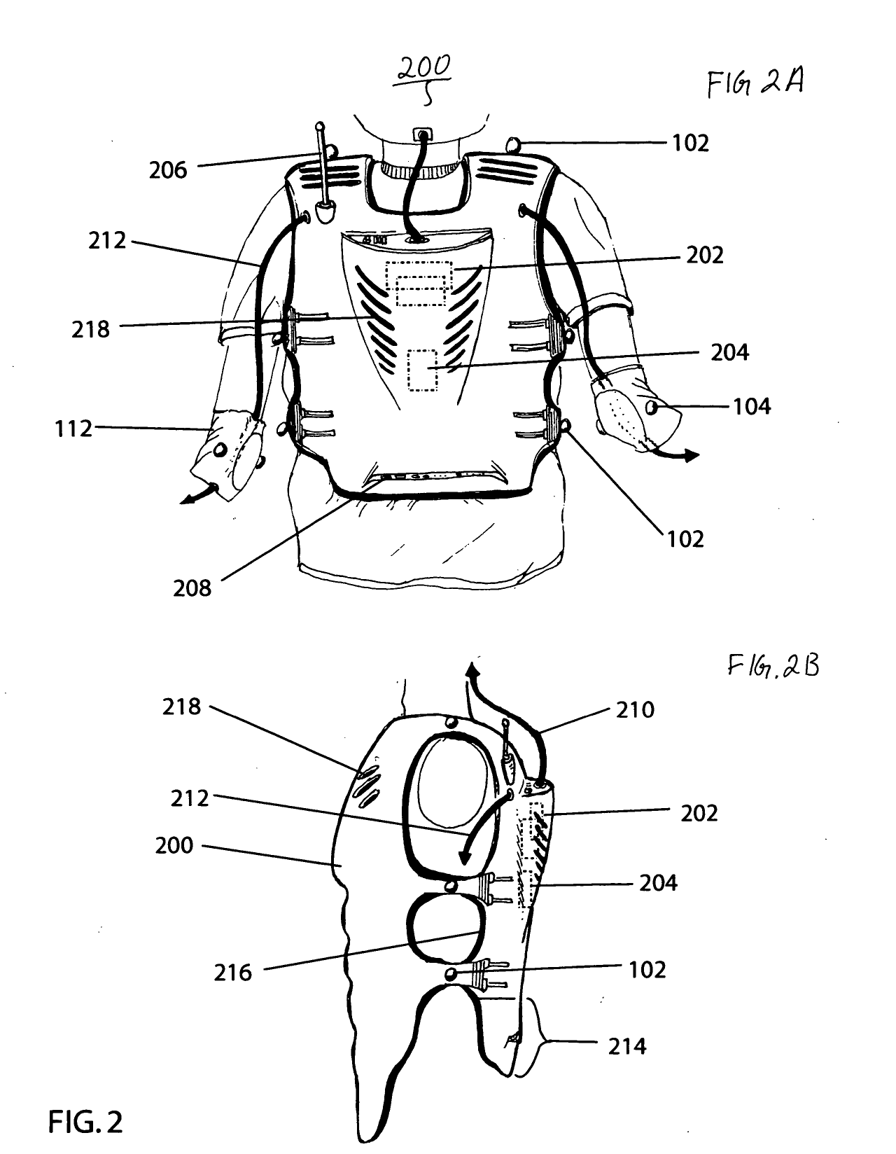

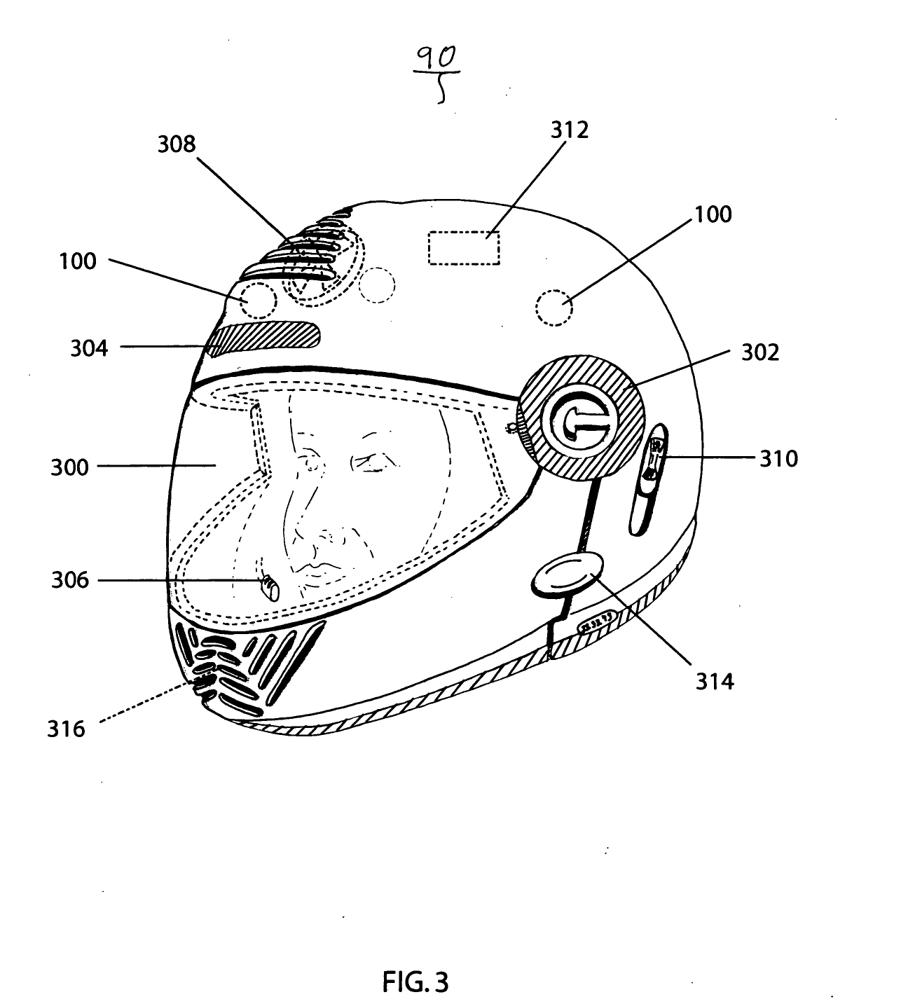

In one embodiment as illustrated in FIG. 1, this may include a user wearable user interface such as a helmet 90 (also see FIG. 3), a virtual reality user module 200 such as a vest (also see FIGS. 2A and 2B), and one or more tracking indicators tracking one or more movements associated with the user in the physical environment and an associated physical coordinate system.

In one embodiment of a virtual reality user interface, the interface includes a display that is transparent until a virtual reality image is displayed. The user interface also includes an audio interface generating an audible sound to the user.

Referring now to FIG. 3, one embodiment of a virtual reality user interface is in the form of a helmet 90. Helmet 90 is configured to be fit on the head of the user and is generally in the shape of a motorcycle helmet. In addition, helmet 90 keeps outside light from interfering with a user's ability to see a display 300; thus resulting in a theater-like environment inside helmet 90. Display 300 may be an Organic Light Emitting Device (OLED) that is composed of amorphous silicon transistors. Display 300 may be any type of display suitable for displaying a image that includes a virtual reality image. In one or more embodiments, features of the display may include a display, such as an OLED, that is transparent until an image or visual data is presented, that can be molded into any shape, and that is thin, light, and is power efficient. Additional features, include bright display colors, improved contrasts, and are less susceptible to breakage and are more impact resistant. Display 300 may be molded into a dome-like shape to fit helmet 90 and to engage a user's peripheral vision. The image display by display 300 may be any image as generated by a virtual reality image signal that may be received from a virtual reality generator or processor (not shown).

Helmet 90 also includes an audio interface 302. Further, audio interface 302 may be capable of generating an audible sound in a surround sound format. This format may be implemented by small headphones such as the SONY® (a registered trademark of Sony Corporation) MDR-DS5100 Advanced Headphone System with DTS® Digital surround sound technology. Headphone that may be suitable as audio interface 302 may be wireless, generate a wide bandwidth of audible sound, and provide high channel separation. In the alternative, an audio interface 302 may include a plurality of speakers situated throughout helmet 90 that are capable of producing surround sound. The audible sound provided by audio interface 302 is a function of an audio signal received by a communication interface (not shown).

Helmet 90 may also include a physical object position sensor 304 that senses a position of an object within a physical coordinate system adjacent to or in a relative position with helmet 90. Sensor 304 may be an infrared sensor that transmits a position request signal and receives a position identification signal that is representative of the position of the physical object. In the alternative, sensor 304 may act just as a receiver. The position identification signal may also be representative of the position of the physical object in relation to helmet 90, and/or the position of the physical object within a physical coordinate system. The physical coordinate system may be either 2-dimensional (i.e., x, y) or 3-dimensional (i.e., x, y, z). In addition, in a multiple user setting, helmet 90 includes a position indicator 100 that allows a second user to receive position identification signals through the use of the second user's sensor 304.

Helmet 90 also includes a force feedback system 312 that generates a physical force to helmet 90. Force feedback system 312 allows the user to physically sense a virtual impact, thus giving the user a more realistic experience while immersed in virtual reality. Additionally, helmet 90 includes a cooling system to keep the user comfortable while wearing helmet 90. A cooling system 308 may include a small fan that may be placed adjacent to the user's forehead. Further, helmet 90 may also include an interior padding (not shown) placed inside helmet 90 in such a way as to provide airflow induced by cooling system 308. The interior padding may be adjusted by a re-sizing device 310 to allow the user maximum comfort while wearing helmet 90. Ventilation holes 316 may also be implemented to further keep the user cool. Helmet 90 may also include a microphone 306 positioned about a mouth of the user. In addition, removal of helmet 90 from a user's head may be accomplished by using a removal button 314. Removal button 314 when depressed will cause the front portion of the helmet to hinge upward and away from the user's head. The user then can easily lift off the back portion of the helmet; thus removing the helmet from the user's head.

In another embodiment of the invention, a virtual reality user module includes a communication module that receives a position signal from an object within a physical interactivity environment. A processing module determines the position of the object in the physical interactivity environment using a physical coordinate system and determines the position of an associated object within a virtual reality coordinate system. Further, the processing module generates a virtual reality image signal that includes the determined position of the associated object within the virtual reality coordinate system.

As illustrated in FIG. 2, one embodiment of a virtual reality user module is in the form of a vest 200. Alternatively, a virtual reality user module could also be other wearable components such as backpack, a fanny pack, a wrist pack, and/or a helmet. The communication module may be a data cord 210 that receives a position signal from an object sensed by sensor 304, and sends the position signal to the processing module. Instead of a data cord, the communication module may include a wireless component 206 with an antenna (not shown) receiving a position signal and transmitting the position signal to the processing module. In another embodiment, the communication module may be a transceiver located on vest 200 that transmits a positioning signal to a physical object positioned within the physical interactivity environment, and receiving a position signal that is responsive to the transmitted positioning signal.

Based on the position signal, a processing module 202 determines the position of an object within the physical coordinate system and then determines the position of an associated object within a virtual reality coordinate system. Further, the VR user module generates a virtual reality signal that includes the determined position of the associated object. The VR user module may also include the direction and movement of the object within the virtual coordinate system that corresponds to a direction and a movement in the physical coordinate system. Furthermore, processing module 202 may identify the associated object, apply a predetermined visual texture to the associated object, create an associated texture (texture may be a 2-dimensional texture, a 3-dimensional textured model, a sprite, and an effect) and then include the associated texture in the virtual reality image signal. Additionally, the virtual image signal may also include the image of the virtual object.

Processing module 202 may include a graphics processing unit for generating the virtual reality image signal. The identity of an associated object, a predetermined visual texture or 2-dimensional or 3-dimensional image of the object and an application of the predetermined visual texture to the associated object may be stored in a memory (not shown). Furthermore, a memory (not shown) may also be used to store a virtual image of the associated object. The memory may be any type of memory storage, including RAM, SRAM, or DRAM.

The physical environment includes a plurality of physical objects having a position on a physical coordinate system. This may include surfaces of walls, corners, desks, as well as one more user body parts or bodies. As discussed above, the physical coordinate system can be either 2-dimensional or 3-dimensional. One or more of the physical objects have corresponding one or more associated objects and one or more virtual reality positions within a virtual reality coordinate system. The virtual reality coordinate system may be about equivalent to the physical coordinate system, or may correlate to the physical coordinate system. The virtual reality image signal generated by processing module 202 includes one or more associated objects within the virtual reality coordinate system. Processing module 202 can exclude one or more of the physical objects and their associated objects when generating the virtual reality image signal. For example, if a physical object were a 20-ft tall ceiling that a user could not touch; processing module 202 may exclude the ceiling and its associated object from the generated image signal so that the virtual image signal includes a sky or a cave ceiling including stalactites.

A VR user module may also include a user interface communication module that communicates the virtual reality image signal to a virtual reality user interface. One embodiment of the virtual reality user interface may be as described above. The user interface communication module may be data cord 210, or wireless component 206. In another embodiment, a VR user module includes a force feedback module that generates a physical force signal that is associated with the virtual reality image signal. For example, if the virtual reality image signal includes a virtual person pushing the user in the chest, a force feedback module may generate a physical force signal at the moment when the virtual person makes associated contact with the user's chest. At the moment of contact, the physical force signal may be transmitted to a force device located on or near the user's chest, thus the creating a feel to the user as if he were indeed pushed by the virtual person in the chest. Additionally, a corresponding audio signal may also be generated such that the user is presented with a corresponding sound.

In an alternative embodiment, the force feedback module generates a physical force signal as a function of a physical interaction of a user with the physical object within the physical interactivity environment. For example, if the physical object in the physical interactivity is a wall with a flat surface and the corresponding virtual image signal is a stone wall, the force feedback module will generate physical force signals that would allow the user to feel a stone wall even though the physical wall in the physical interactivity environment has a flat surface.

The physical force signal generated by the force feedback module is communicated to the user in the form of a physical sensation through the use of a force feedback communication module and actuator. An example of the communication module is force feedback system 312 located on helmet 90. Force feedback systems can be implemented at any location on a user's body, including the torso, arms, legs, hands, feet, and head. Implementing these force feedback actuated systems provides the user with physical sensations as described in the examples above.

In addition to the force feedback system, a pressure sensor system 118, as illustrated in FIG. 1, may also be used to enhance the virtual experience. For example, pressure sensors may be used to create and audio signal or sound as a function of the pressure sensed associated with pressure applied by the user's feet in the physical environment. Pressure sensor system 118 may be pressure sensors that sense the pressure of the user's footsteps, and a pressure communication system (not shown) that communicates the pressure sensed by the pressure sensors to the VR user module. In another embodiment, the pressure sensors may be associated with a users hand or finger as applied to a physical object in the physical environment.

The pressure communication system may simply be a data cord that connects the sensors to the VR user module, but may also be wireless. The VR user module may then generate an audio signal as a function of the sensed pressure and then transmits the signal to an audio interface. Thus, if the user is walking and applying pressure, the audio signal generated by the VR user module may be adjusted based on the pressure applied by the user, e.g., louder when running hard and softer when tip-toeing.

In order to maintain power to the communications module and processing module 202, one embodiment of the VR user module may include an energy source 214 that is self-contained. Energy source 214 could be at least one of a removable battery, a rechargeable battery, and a fuel cell.

Additionally, in order to keep the user comfortable a resistant layer is positioned between the VR user module and a body of a user. For example, if the VR module is vest 200, a resistant layer 216 is placed between vest 200 and the user. To keep the vest cool, ventilation holes 218 may be implemented. Additionally, for the user's protection, heart beat, blood pressure, and breathing sensors may be included in the user module and received by the local processor or provided by a remote user monitoring system. One embodiment of these sensors may be through the use of a health monitoring bracelet 122 in FIG. 1. By monitoring the health of the user, serious injury may be prevented. Additionally, a mid protective wear 114 and a mid leg protective wear 116 may also be implemented to further protect the user. Mid-arm protective wear 114 may be in the form of elbow pads, and mid arm protective wear 116 may be in the form of knee pads.

In another embodiment of the invention, a virtual reality interactivity system may be a physical environment configured and equipment for virtual reality simulation and interactivity. The system may be a room or any enclosure containing a plurality of position indicators. Each of the plurality of position indicators is associated with one of plurality of objects located in a physical environment and mapped by the physical coordinate system. The objects may be a wall, a ceiling, a floor, a knob, a steering wheel, a step, a surface, a freely movable object, a table, a hand held device, a vehicle simulator, a position of a body part of the user, and a position of a body part of a second user. One or more of the position indicators may be associated with each object such as to identify features, edges, or points of interest that may be mapped from the physical coordinate system describing the location of the indicator point and the object to a virtual reality coordinate system and a mapped or assigned associated object in the virtual reality environment.

The virtual reality interactivity system also has a communication system for communicating the plurality of positions of the position indicators to a VR user module. The VR module determines a position of a physical object within the physical coordinate system and determines a position of an associated object within the virtual reality coordinate system, and generates a virtual reality image signal. The virtual reality interactivity system also includes a virtual reality user interface providing a virtual reality image to the user as a function of the virtual reality image signal.

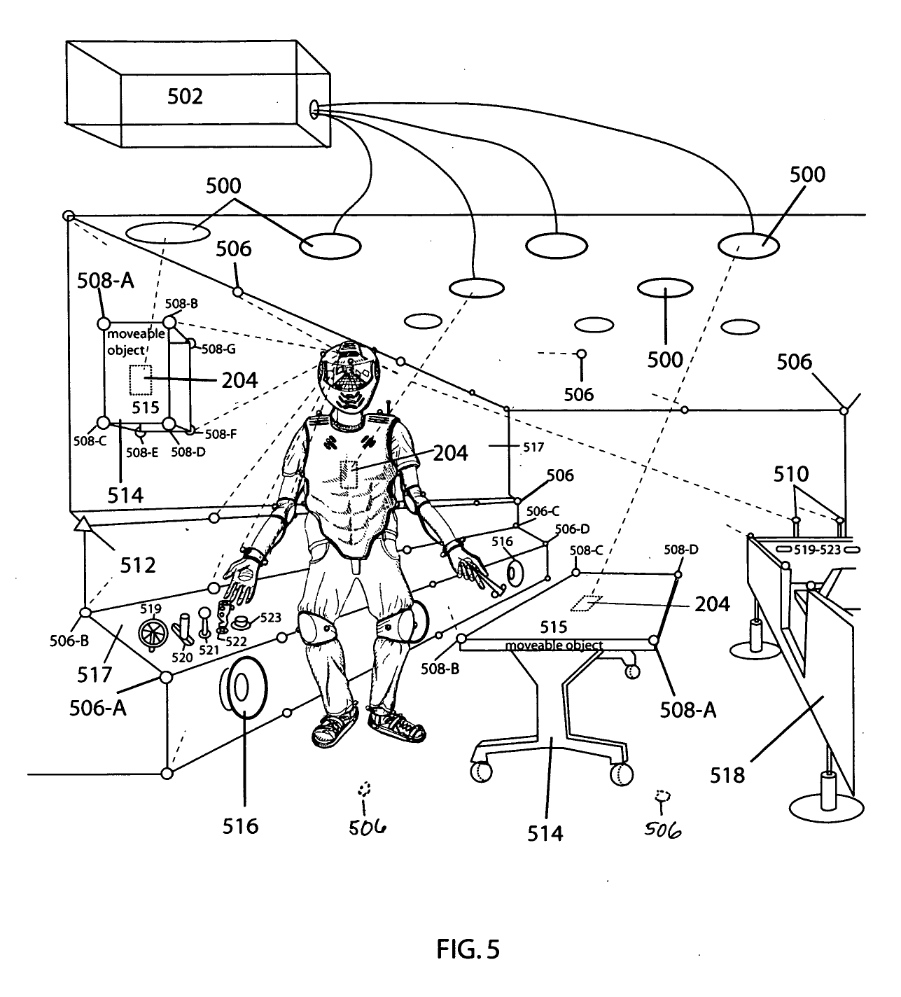

As illustrated in FIG. 5, one embodiment of a virtual reality interactivity system includes a plurality of position indicators located throughout the interactivity system. The position indicators can be associated with objects including, a wall, a ceiling, a floor, a knob, a steering wheel, a step, a surface, a freely moveable object, a table, a position of a body part of the user, and a position of a body part of a second user. For example, a moveable object (table) 514 may have position indicators 508 A-D defining a surface 515; and a moveable object (box) 514 may have position indicators 508 A-G wherein similarly 508A-D define one of the surface 515 of box 514. Position indicators may also be located on walls and ceilings as exemplified by position indicators 506, 506 A-D; and on the user as exemplified by position indicators 100, 102, 104, 106, 108, and 110. Furthermore, position indicators located on a body part of one or more users within the environment provide for identifying movement and rotation, such as wrists and ankles, each of which may contain multiple position indicators in order to correctly track the rotation of these body parts. Additionally, position indicators may be placed on data gloves 120 for tracking the movement of a user's palm and fingers. Data gloves 120 may also contain a force feedback system as described above to enhance the user's sense of touch in the virtual environment. Data gloves 120 may also communicate the movement of a user's palm and fingers through the use of a data cord, or wirelessly to the VR user module. Position indicators may be active or passive and may be reflectors, magnetic material, or metal. There may also be a reference position indicator 512 that when identified will allow the VR user module to calibrate the VR coordinate system in correlation to the physical coordinate system.

The position communication system may be sensor 304, or wireless component 206, as each is described above. The VR user module, in one embodiment, may be similar to the VR user module described above. The VR user interface may be display 300 as described above, or it may be a display substantially in the shape of eye-glasses, or some sort of screen placed in front of the user that is capable of displaying a virtual reality image. In addition to including the determined position of an associated object within the virtual reality coordinate system, the virtual reality image signal generated by the VR user module may also include an associated direction and movement of the associated object within the virtual coordinate system that corresponds to the object's direction and movement within the physical coordinate system.

After the VR user module identifies an identity of the associated object, it may apply a predetermined visual texture or virtual image to the associated object. This may also include an associated object texture or image with one or more dimension that are different than the dimension of the physical object, but that corresponds the physical object to the identified position, e.g., a box may be representative of a boulder having an irregular virtual image shape. The virtual reality image signal generated by the VR user module may include the associated texture or image as a function of the applied texture or image. The VR user module may also include an audio module and/or a force feedback module generating an audio signal and/or a physical force signal associated with the virtual reality image signal. One embodiment of the force feedback module may be as discussed above.

The interactivity system may also have an object location indicator 204 to provide an identification and location of a physical article within the physical coordinate system. Object location indicator 204 may be associated with any of several articles including a wall 517, a ceiling, a floor, a knob 521, a steering wheel 519, a lever 520, a joy stick 522, a button 523, a step, a surface, a freely moveable object, a table, a position of a body part of the user, and a position of a body part of a second user. A location communication system 500 may be used to communicate the identification and location of a physical article to a location processing system 502 wirelessly. Location communication system 500 may be implemented with sensors that are capable of tracking object location indicators. Location processing system 502 determines the identification of the article and the location of the article within the physical coordinate system, and location communication system 500 transmits wirelessly the determined article identification and physical coordinate position to a VR user module. In addition, location communication system 500 may also track object location indicators, communicate with location processing system 502, and transmit identification and location information to a VR user module through the use of wires. The VR user module, after receiving the determined article identification and physical coordinate position, further determines the identification of an associated article corresponding to the determined article, and the location of the associated article within the virtual reality coordinate system.

For example, if object location indicator 204 is placed on box 514, location communication system 500 will communicate the identification and location of box 514 to location processing system 502. Location processing system 502 will then identify the article as box 514 and will determine its physical location based on a physical coordinate system. This information will then be transmitted to the VR user module. The VR user module will then identify an associated object corresponding to box 514 that may be a treasure chest, and will identify the location of the treasure chest in a virtual reality coordinate system corresponding to the location of box 514 in the physical coordinate system.

In another embodiment, location indicator 204 provides an identification of an article in the physical environment, and a location of the article within the physical coordinate system. Location communication system 500 communicates the identification and location of the article to a VR user module. The VR user module determines the identification of the article and the location of the article within the physical coordinate system, and identifies an associated article corresponding to the article and a location of the associated article within the virtual reality coordinate system. The VR user module may also generate a virtual reality image signal as a function of the determined identification and location of the associated article. Further, the VR user module, may also determine a direction and a movement of the article within in the physical coordinate system based on the information it receives from the location communication system, and then determine a direction and a movement of an associated article within the virtual coordinate system. The virtual reality image signal may also include the direction and movement of the associated article.

In another embodiment the virtual reality interactivity system may include a subwoofer 516 located in the physical environment that generates low frequency bass and related vibration as a function of the virtual reality image signal.

As an example of just one embodiment of an object in the virtual reality interactivity environment, a vessel 518 in the physical environment may simply be a rectangular box-like structure with a seat located therein. However, once the position indicators identify the box and the position within the physical environment and physical coordinate system, the VR user module or a processing system thereof may map the box into being an associated object such as a helicopter. Such an associated object image is generated and may have one or more virtual reality textures applied to the position of the box in the physical environment, such that the virtual reality image is displayed to be the helicopter.

Additionally, one or more modules may also generate a force feedback signal associated with the current or moved position of the box in the physical or virtual reality environment. The force feedback system may also trigger physical sensations such as vibrations and movements that would be similar to that of a helicopter, thus enhancing the virtual experience. Additionally, sound may be generated to replicate the sound of the helicopter including the generation of subwoofer vibrations. Such combined user interactivity with audio, force feedback, and virtual reality image enables the user to sit in vessel 518 and have the feeling of being in a helicopter. Additionally, vessel 518 may include steering wheel 519, lever 520, knob 521, joystick 522, and button 523 that may correspond to helicopter controls in the virtual environment. Vessel 518 may also include an object location indicator.

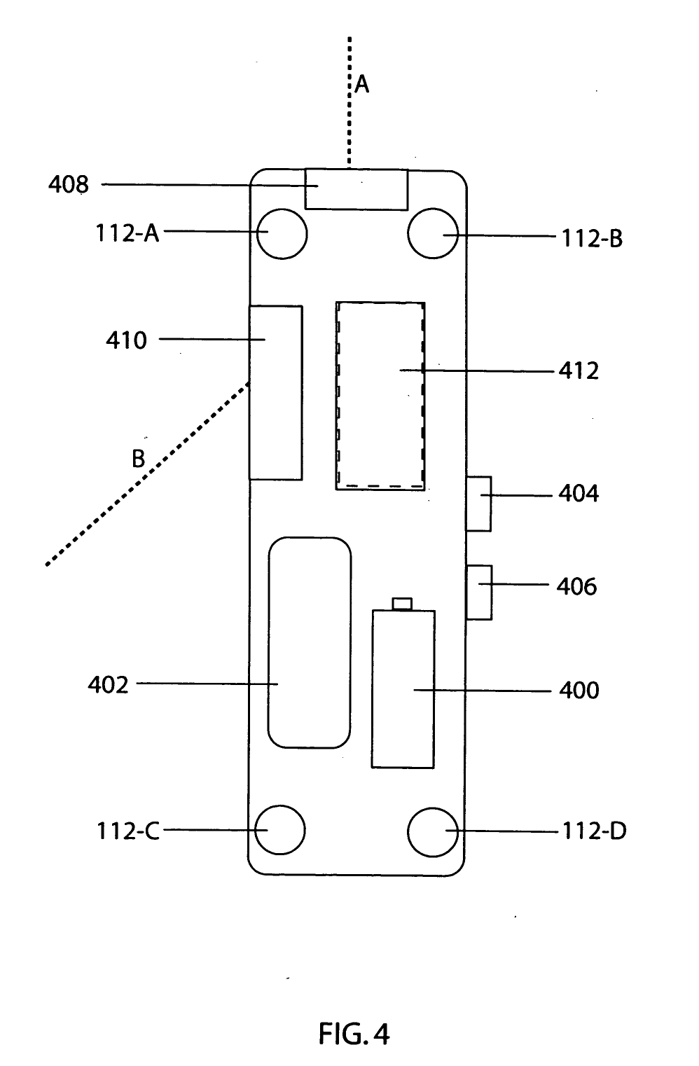

Referring now to FIG. 4, the interactivity environment may include a hand held device 124. Device 124 is substantially in the shape of a rectangle but can be in any type of shape when applied an image and/or texture in the virtual environment and virtual reality image signal. In addition, device 124 is a physical object that the user interacts with in the interactivity environment and such interaction corresponds to interactions with the corresponding device in the virtual environment. For example, device 124 includes position indicators 112 A-D. These position indicators may be sensed by a position communication system, or by a communications module located on a VR user module, and will communicate the positions of the position indicators to the VR user module. The VR user module will then be able to identify the object as device 124, and will identify an associated object. For this example, the associated object will be a pulse rifle and may include an interactive button that corresponds to a trigger in the VR environment. The pulse rifle is just for exemplary purposes and the associated object can be any object that the VR module is programmed to identify when device 124 is identified. After the object is identified, the VR module applies the corresponding texture for the particular virtual reality experience such as applying an image or texture of a pulse rifle or a guitar. The VR image signal is generated and provided to a display such as display 300 on VR user interface for displaying. Although device 124 is a physical object substantially in the shape of a rectangle, the display will image device 124 through display 300 in the VR environment as a pulse rifle.

Further, device 124 also includes a primary button 404 and a secondary button 406. These buttons, when physically depressed, will have a corresponding effect in the virtual environment. For example, when button 404 is depressed it transmits a signal wirelessly through a communication device 410 to the VR user module. The VR user module will identify this signal as coming from button 404 and will then identify an associated movement that could be the pulling of a trigger. Again, this movement is for exemplary purposes and can be any associated movement. After the associated movement is identified, the VR user module will then apply a texture corresponding to the associated movement that means applying the pulling of a trigger on the pulse rifle. This movement will be transmitted to the user interface and will be displayed on display 300. So although the user pressed physical button 404, the user will see on display 300 the firing of a pulse rifle. Button 406 will function similarly, but may have a different associated movement programmed in the VR user module. Device 124 may also include an object location indicator 412, an energy storing device 400 such as a rechargeable battery, and a force feedback system 410 as described above. Using the pulse rifle example, once button 404 is depressed, the user will see the firing of a pulse rifle, and will be able to feel the recoil of the pulse rifle.

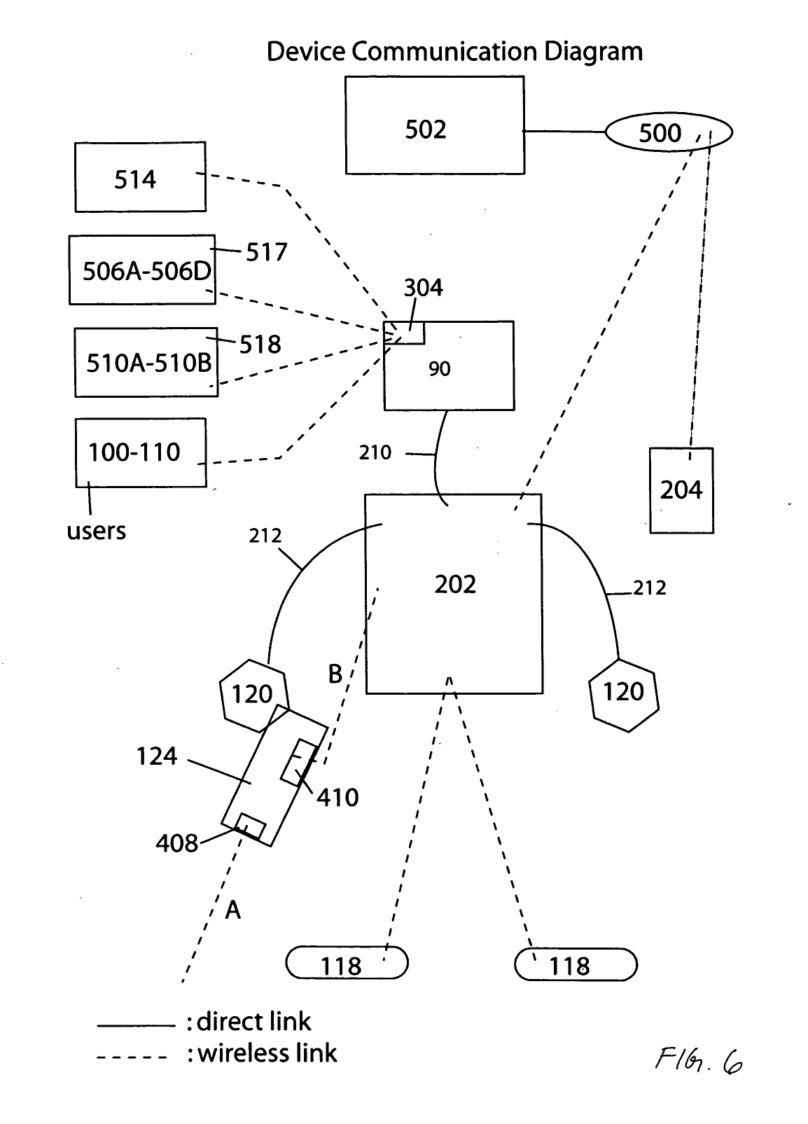

FIG. 6 illustrates a variety of the communication flows within the virtual reality interactivity environment according to some embodiments of the invention. As illustrated, user module 202 is linked to user interface 90 via communication link 210 for providing communications as described above. Similarly, data gloves 120 are communicatively coupled to user module 202 via data links 212. Pressure sensors 118 may be located on the user's feet and communicate pressure signal to user module 202. As illustrated and discussed above, device 124 communicates with user module 202.

Also as discussed above, various position indicators 100-110, 506A-D, and 510A-B are active or passive position indicators providing a position signal that is received by position sensor 304. Sensor 304 may be located on a helmet of the user, another location on the user, or within the virtual reality interactivity environment. A plurality of object location indicators 204 communication the identification and location of an object within the interactivity environment via the location communication system 500 to the location processing system 502. Location processing system 502 communicates the location of the object to the user module 202 to provide the identification and location of the object within the interactivity environment.

In the operation of the virtual reality interactivity environment, a user moves through a physical environment that includes physical objects such as a wall, ceiling, a floor, a rock, a crate, a vehicle simulator, a knob, a steering wheel, a joystick, a step, a table, and the body parts of the user and of a second user. While navigating the physical environment, the user will be seeing through a virtual reality display. So although the user will not be able to see the actual physical objects, he will be able to see virtual objects that correspond to the physical objects. The physical environment that the user moves through has generally the same dimensions of the virtual environment. Physical objects that are not within the user's reach may not need to be constructed with the same dimensions as the virtual environment. For example, a ceiling that cannot be touched by the user because it is 20 feet tall in the physical environment could correspond to a sky in the virtual environment and not necessarily a virtual ceiling that is 20 feet tall.

The physical environment may not need to be rendered with color, because the VR user module will create the virtual images, sounds, movements, and textures for the virtual environment. In one embodiment, the interaction in the physical environment having a corresponding effect in the virtual environment is accomplished through a plurality of position indicators placed throughout the physical environment and a sensor mounted on each user. This sensor will sense the position indicators and the VR user module will output a corresponding virtual image that will be displayed to the user. In addition, to the position indicators, physical objects may also have object location indicators that will further aid the VR user module in determining the location of objects within the virtual environment.

As discussed above, virtual reality user module and one or more other modules and system may be implemented in a processor or processing operating environment. Such system may include, a computer system or processor (not shown) that comprises at least one high speed processing unit (CPU), in conjunction with a memory system, an input device or interface, and an output device or interface. These elements may be interconnected by one or more bus or serial communications structure or facilities.

The CPU 24 may be of familiar design and includes an ALU for performing computations, a collection of registers for temporary storage of data and instructions, and a control unit for controlling operation of the system. Any of a variety of processors, including at least those from Digital Equipment, Sun, MIPS, Motorola, NEC, Intel, Cyrix, AMD, HP, and Nexgen, are equally preferred for the CPU and may be implemented as a single processing unit or a plurality of processing units. Some embodiments of the invention operate on an operating system designed to be portable to any of these processing platforms.

The memory system generally includes high-speed main memory in the form of a medium such as random access memory (RAM) and read only memory (ROM) semiconductor devices, and secondary storage in the form of long term storage mediums such as floppy disks, hard disks, tape, CD-ROM, flash memory, etc. and other devices that store data using electrical, magnetic, optical or other recording media. The main memory also can include video or graphics display memory for generating the virtual reality image signal for displaying images through a display device. Those skilled in the art will recognize that the memory can comprise a variety of alternative components having a variety of storage capacities.

The input and output devices also are familiar. The input device can comprise a keyboard, a mouse, touch pad, a physical transducer (e.g. a microphone), or a communication port or interface. The output device can comprise a display, a printer, a transducer (e.g. a speaker), or a communication port or interface. Some devices, such as a network adapter, network interface, or a modem, can also be used as input and/or output devices.

As is familiar to those skilled in the art, a processing or computer system described herein further includes an operating system and at least one application program such as a virtual reality interactivity or generation program. The operating system is the set of software that controls the computer system's operation and the allocation of resources. The application program is the set of software that performs a task desired by the user, using computer resources made available through the operating system such as the generation of the virtual reality image signal. Both are resident in the memory.

In accordance with the practices of persons skilled in the art of computer programming, the present invention is described above with reference to symbolic representations of operations that are performed by one or more processing systems or modules. Such operations are sometimes referred to as being computer-executed. It will be appreciated that the operations that are symbolically represented include the manipulation by the CPU of electrical signals representing data bits and the maintenance of data bits at memory locations in the memory system, as well as other processing of signals. The memory locations where data bits are maintained are physical locations that have particular electrical, magnetic, or optical properties corresponding to the data bits. Some embodiment of the invention can be implemented in a program or programs, comprising a series of instructions stored on a computer-readable medium. The computer-readable medium can be any of the devices, or a combination of the devices, described above in connection with the memory system.

When introducing aspects of the invention or embodiments thereof, the articles “a”, “an”, “the”, and “said” are intended to mean that there are one or more of the elements. The terms “comprising”, “including”, and “having” are intended to be inclusive and mean that there may be additional elements other than the listed elements.

In view of the above, it will be seen that several aspects of the invention are achieved and other advantageous results attained. As various changes could be made in the above exemplary constructions and methods without departing from the scope of the invention, it is intended that all matter contained in the above description or shown in the accompanying drawings shall be interpreted as illustrative and not in a limiting sense.

It is further to be understood that the steps described herein are not to be construed as necessarily requiring their performance in the particular order discussed or illustrated. It is also to be understood that additional or alternative steps may be employed.

What is claimed is:

1. A virtual reality user interface comprising:
a display having a transparent mode and a display mode, said transparent mode providing transparent viewing to a user of the VR user interface, said display mode displaying a virtual reality image; and
an audio interface generating an audible sound.

2. The VR user interface of claim 1 wherein the audio interface includes a surround sound format.

3. The VR user interface of claim 1, further comprising a physical object position sensor sensing a position of a physical object within a physical coordinate system.

4. The VR user interface of claim 3 wherein the sensor includes a transmitter for transmitting a position request signal and receiving a position identification signal representative of the position of the physical object.

5. The VR user interface of claim 4 wherein the received position identification signal is representative of the position of the physical object relative to the VR user interface.

6. The VR user interface of claim 4 wherein the received position identification signal is representative of the position of the physical object within a physical coordinate system.

7. The VR user interface of claim 3, further comprising a communication interface transmitting the sensed object position, said virtual reality image signal being responsive to the transmitted sensed object position.

8. The VR user interface of claim 6 wherein the communication interface communicates with a VR user module generating the VR image signal, at least in part, as a function of the transmitted sensed object position.

9. The VR user interface of claim 1 wherein the display includes at least one of a thin durable transparent composition and a flexible display screen.

10. The VR user interface of claim 1, further comprising a force feedback system generating a physical force to the user interface and the user interface user.

11. The VR user interface of claim 10, further comprising a communication interface receiving a virtual reality force feedback signal and providing the force feedback signal to the force feedback system.

12. The VR user interface of claim 1 wherein the VR user interface is a helmet.

13. The VR user interface of claim 12 wherein the helmet includes a helmet cooling system.

14. The VR user interface of claim 13 wherein the helmet further includes an interior padding positioned to an interior surface of the helmet and providing user airflow induced by the helmet cooling system.

15. The VR user interface of claim 1, further comprising a VR user interface position indicator.

16. The VR user interface of claim 1, further comprising a microphone positioned about a mouth of the user.

17. The VR user interface of claim 1, further comprising a communication interface receiving a virtual reality image signal, said display displaying the virtual reality image as a function of the virtual reality image signal.

18. The VR user interface of claim 17 wherein the received virtual reality image signal is generated by a virtual reality user module.

19. The VR user interface of claim 1, further comprising a communication interface receiving an audio signal, said audio interface providing the sound as a function of the audio signal.

20. A virtual reality user module for generating a virtual reality image signal corresponding at least in part to a physical coordinate system, the VR user module comprising:
a communication module receiving a position signal from an object within a physical interactivity environment defined at least in part by the physical coordinate system; and
a processing module determining a position of the object within the physical coordinate system responsive to the received position signal and determining a position of an associated object within the virtual reality coordinate system, said processing module generating a virtual reality image signal including the determined position of the associated object within the virtual reality coordinate system.

21. The VR user module of claim 20 wherein the processor identifies an identity of the associated object, applies a predetermined visual texture to the associated object, and generates the virtual reality image signal including the associated texture as a function of the applied texture.

22. The VR user module of claim 21, further comprising a memory storing the predetermined visual texture and an association of the predetermined texture to the identity of the associated object.

23. The VR user module of claim 20, further comprising a force feedback module generating a physical force signal associated, at least in part, with the virtual reality image signal.

24. The VR user module of claim 23 wherein the force feedback module generates the physical force signal as a function of a physical interaction of a user with the physical object within the physical interactivity environment.

25. The VR user module of claim 23, further including a force feedback communication module communicating the physical force signal to a virtual reality user interface providing force feedback to a user of the virtual reality user interface.

26. The VR user module of claim 20, further comprising an energy source for powering one or more modules of the VR user module.

27. The VR user module of claim 26 wherein the energy source is self-contained and includes at least one of a removable battery, a rechargeable battery, and a fuel cell.

28. The VR user module of claim 20 wherein the virtual reality VR user module is configured as a user wearable component.

29. The VR user module of claim 28 wherein the user wearable component is at least one of a vest, a backpack, a fanny pack, a wrist pack, and a helmet.

30. The VR user module of claim 20, further comprising a heat resistant layer positioned between the VR user module and a body part of the user.

31. The VR user module of claim 20 wherein the communication module includes a wireless communication module.

32. The VR user module of claim 20 wherein the communication module includes a transmitter for transmitting a positioning signal to the physical object positioned within the physical interactivity environment, said received position signal being responsive to the transmitted positioning signal.

33. The VR user module of claim 20 wherein the processing module includes a graphics processing unit for generating the virtual reality image signal.

34. The VR user module of claim 20 wherein the physical interactivity environment includes a plurality of physical objects, each of the plurality of physical objects having a physical coordinate system position, and wherein one or more of the physical objects have corresponding one or more associated objects and one or more virtual reality position within the virtual reality coordinate system, wherein the processing module generates the virtual reality image signal to include the one or more associated objects within the virtual reality coordinate system.

35. The VR user module of claim 34 wherein the processing module generates the virtual reality image signal to exclude one or more of the plurality of physical objects and their associated objects in generating the virtual reality image signal.

36. The VR user module of claim 34, further including a memory storing an image of a virtual object having a virtual position within the virtual reality coordinate system, wherein the generated virtual reality image signal includes the image of the virtual object.

37. The VR user module of claim 20, further including a memory storing a virtual image of the associated object, wherein the generated virtual reality image signal includes the image of the virtual object.

38. The VR user module of claim 20, further including a user interface communication module communication the virtual reality image signal to a virtual reality user interface.

39. The VR user module of claim 20 wherein the virtual reality image signal includes a direction and a movement of the object within the physical coordinate system.

40. A virtual reality interactivity system comprising:
a plurality of position indicators indicating a plurality of positions in a physical coordinate system, each of said plurality of position indicators being associated with one of plurality of objects located in a physical environment mapped by the physical coordinate system;
a position communication system for communicating the plurality of positions of the plurality of position indicators;
a virtual reality user module associated with a user positioned within the physical environment, said VR user module determining a position of an object within the physical coordinate system responsive to the plurality of position signals and determining a position of an associated object within the virtual reality coordinate system, said VR user module generating a virtual reality image signal including the determined position of the associated object within the virtual reality coordinate system; and
a virtual reality user interface displaying a virtual reality image to the user as a function of the virtual reality image signal.

41. The system of claim 40, further comprising:
an object location indicator providing an identification of an article within the physical environment and providing a location of the article within the physical coordinate system;
a location communication system for communicating the identification and location of the article; and
a location processing system determining the identification of the article and the location of the article within the physical coordinate system, said location communication system transmitting the determined article identification and physical coordinate position to the VR user module, and said VR user module identifying an associated article corresponding to the determined article and a location of the associated article within the virtual reality coordinate system.

42. The system of claim 41 wherein the position communication system and the location communication system are each a wireless communication system.

43. The system of claim 40, further comprising:
a location indicator providing an identification of an article within the physical environment and providing a location of the article within the physical coordinate system; and
a location communication system for communicating the identification and location of the article, wherein said VR user module identifies an associated article corresponding to the determined article and a location of the associated article within the virtual reality coordinate system.

44. The system of claim 43 wherein the VR user module generates the virtual reality image signal as a function of the identification of the associated article and the location of the associated article within the virtual reality coordinate system.

45. The system of claim 43 wherein the virtual reality image signal includes a direction and a movement of the associated article within the virtual reality coordinate system that corresponds to a direction and a movement of the article within the physical coordinate system.

46. The system of claim 43 wherein the location indicator is associated with an article selected from the group consisting of the user interface, a wall, a ceiling, a floor, a knob, a steering wheel, a step, a surface, a freely movable object, a table, a hand held device, a vehicle simulator, a position of a body part of the user, and a position of a body part of a second user.

47. The system of claim 40 wherein the virtual reality coordinate system correlates to the physical coordinate system.

48. The system of claim 40 wherein a dimension of the physical coordinate system is about equivalent to a dimension of the virtual coordinate system.

48. The system of claim 40 wherein at least one of the plurality of position indicators is associated with a position of a body part of the user.

49. The system of claim 40 wherein at least one of the plurality of position indicators is associated with a position of an object movable within the physical environment.

50. The system of claim 40 wherein the virtual reality image signal includes a direction and a movement of the associated object within the virtual reality coordinate system that corresponds to a direction and a movement of the object within the physical coordinate system.

51. The system of claim 40 wherein at least one of the plurality of position indicators is associated with an object selected from the group consisting of the user interface, a wall, a ceiling, a floor, a knob, a steering wheel, a step, a surface, a freely movable object, a table, a hand held device, a vehicle simulator, a position of a body part of the user, and a position of a body part of a second user.

52. The system of claim 40, further comprising a subwoofer positioned within the physical environment and generating low frequency bass and related vibration at least in part associated with the virtual reality image signal.

53. The system of claim 40 wherein the VR user module identifies an identity of the associated object, applies a predetermined visual texture to the associated object, and generates the virtual reality image signal including the associated texture as a function of the applied texture.

54. The system of claim 53 wherein the VR user module includes a memory storing the predetermined visual texture and an association of the predetermined texture to the identify of the associated object.

55. The system of claim 40 wherein the VR user module includes a force feedback module generating a physical force signal associated, at least in part, with the virtual reality image signal.

56. The system of claim 55 wherein the force feedback module generates the physical force signal as a function of a physical interaction of the user with one of the plurality of objects within the physical environment.

57. The system of claim 40 wherein the VR user module is configured as a user wearable component.

58. The system of claim 40 wherein the VR user module includes a memory storing an image of a virtual object having a virtual position within the virtual reality coordinate system, wherein the generated virtual reality image signal includes the image of the virtual object.

59. The system of claim 40 wherein the VR user module includes a memory storing a virtual image of the associated object, wherein the generated virtual reality image signal includes the image of the virtual object.

60. The system of claim 40 wherein the user interface includes an audio interface associated, at least in part, with the virtual reality image signal.

61. A method of operating a virtual reality user system, the method comprising:
receiving a position signal from an object within a physical interactivity environment defined at least in part by a physical coordinate system;
determining a position of the object within the physical coordinate system as a function of the received position signal;
determining a position of an associated object within the virtual reality coordinate system; and
generating a virtual reality image signal including the associated object and the position of the associated object within the virtual reality coordinate system.

61. The method of claim 60, further comprising:
associating the associated object with the physical object;
applying a predetermined visual texture to the associated object;
and generating the virtual reality image signal including the associated object with the applied predetermined visual texture.

62. The method of claim 60, further comprising generating a physical force signal associated, at least in part, with the virtual reality image signal.

63. The method of claim 60, further comprising generating an audio signal associated, at least in part, with the virtual reality image signal.

64. The method of claim 60, further comprising transmitting the position signal from the physical object within the physical interactivity environment.

65. The method of claim 60, further comprising displaying a virtual reality image as a function of the virtual reality image signal, said displayed image being a function of the position of the object in the physical coordinate system.

66. The method of claim 60, further comprising determining an identification of the object in the physical interactivity environment and determining a location of the object within the physical coordinate system.
